(19) United States
(12) Patent Application Publication
(10) Pub. No.: US 2007/0002338 A1
(43) Pub. Date: Jan. 4, 2007

(54) Method and apparatus for managing print data

(75) Inventor: Hyun-chul Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/473,012

(22) Filed: Jun. 23, 2006

(30) Foreign Application Priority Data
Jun. 30, 2005 (KR) 10-2005-0058603

(51) Int. Cl. G06F 3/12

(52) U.S. Cl. 358/1.1; 358/1.14

(57) ABSTRACT

A method for managing print data and an apparatus for performing the same are provided. The method for managing print data includes the steps of checking whether printable condition data corresponding to print data is provided, and, if printable condition data is not provided, generating printable condition data by obtaining printable condition data corresponding to a keyword input by a user.

### CROSS-REFERENCE TO RELATED PATENT APPLICATION

This application claims the benefit under 35 U.S.C. § 119(a) of Korean Patent Application No. 10-2005-0058603, filed on Jun. 30, 2005, in the Korean Intellectual Property Office, the entire disclosure of which is hereby incorporated by reference.

### BACKGROUND OF THE INVENTION

1. Field of the Invention

The present invention relates to print data management. More particularly, the present invention relates to a method and apparatus for managing print data so that when print data is supplied without printable condition data (that is, at least one condition for determining whether the print data may be printed), printable condition data is generated based on the content of the print data. Moreover, the present method and apparatus relates to a method and apparatus for managing print data so that stored print data is deleted only when an instruction to delete the print data is received from a user.

2. Description of the Related Art

An image forming apparatus such as a printer receives print data and instructions from a host device connected to the image forming apparatus. The image forming apparatus can print the image data, and can also store the print data so that it can be reprinted.

When a user requests the image forming apparatus to reprint print data, the image forming apparatus reads the print data to be reprinted from the image forming apparatus and prints the print data, without the operation of the host device.

When secure printing is performed using the image forming apparatus, a security level must be set with respect to the content of the stored print data. This security level must be stored in the image forming apparatus together with the print data. Also, a retention period which corresponds to the security level should be stored in the image forming apparatus.

If print data is stored in the image forming apparatus, and the security level is not stored in the image forming apparatus, an authenticated user must set the security level of the stored print data. To do this, the user must know the content of the print data. However, the user setting the security level may not know the content of the print data. For example, the user setting the security level may not be the user who instructed the image forming apparatus to store the print data, or the user who instructed the image forming apparatus to store the print data may forget the content of the print data (due to the passage of time, for example). In such cases, it is difficult for a user to select the appropriate security level.

Also, when the designated retention period elapses, the stored print data is unconditionally and automatically deleted. Accordingly, even if the stored print data should be retained for a longer period than the initially set retention period due to changed circumstances, the print data is automatically deleted when the retention period elapses.

As a result, in a conventional method for managing print data, a user who does not know the content of the stored print data cannot set the security level of the print data. Further, in a conventional method for managing print data, since the print data is unconditionally deleted when the retention period elapses, a user cannot adjust the retention period of the stored print data.

Accordingly, there is a need for an improved method for setting the security level of print data and flexibly adjusting the retention period of the print data.

### SUMMARY OF THE INVENTION

An aspect of the present invention is to address at least the above problems and/or disadvantages and to provide at least the advantages described below. Accordingly, an aspect of the present invention is to provide a method for managing print data which, when printing print data without printable condition data, evaluates the content of the print data, generates printable condition data corresponding to the result of the evaluation, and only deletes the print data when a instruction to delete the print data is received from a user, even though an initially set retention period has elapsed.

The present invention also provides a print data managing apparatus which, when printing print data without printable condition data, evaluates the content of the print data, generates printable condition data corresponding to the result of the evaluation, and only deletes the print data when a instruction to delete the print data is received from a user, even though an initially set retention period has elapsed.

The present invention also provides a computer-readable medium having embodied thereon a computer program which, when printing print data without printable condition data, evaluates the content of the print data, generates printable condition data corresponding to the result of the evaluation, and only deletes the print data when a instruction to delete the print data is received from a user, even though an initially set retention period has elapsed.

According to an aspect of the present invention, a method for managing print data comprises the steps of checking whether printable condition data which corresponds to print data is provided, and, if printable condition data is not provided, generating printable condition data by obtaining printable condition data corresponding to a keyword input by a user.

In an exemplary embodiment, the step of generating printable condition data may comprise the steps of reading a security level corresponding to the input keyword, assigning the security level to the print data, and generating printable condition data by obtaining printable condition data corresponding to the assigned security level.

In an exemplary embodiment, the step of generating printable condition data may comprise the steps of receiving printable condition data, and generating printable condition data based on the received printable condition data.

In an exemplary embodiment, the method may further comprise the steps of checking whether the time when an instruction to print the print data was given is within a printable time contained in the generated printable condition data, and printing the print data if the time when the instruction to print the print data was given is within the printable time.

In an exemplary embodiment, the method may further comprise the steps of checking whether the time when an instruction to print was given is within a printable time contained in the generated printable condition data, and, if the time when the instruction to print the print data was given is not within a printable time contained in the generated printable condition data, allowing a user to select whether to delete print data, and deleting the print data if the user chooses to delete the print data.

In an exemplary embodiment, the user may select a place from which the print data is read.

In an exemplary embodiment, the method may further comprise the steps of checking whether the input keyword exists in at least one of a name of a print file having the print data or the print data, if printable condition data is not provided, and generating printable condition data, if the keyword exists in at least one of the name of a print file having the print data or the print data.

In an exemplary embodiment, printable condition data may comprise at least one of a printable time of the print data and a printable number of the print data.

In an exemplary embodiment, the method may further comprise the steps of checking whether the time when an instruction to print was given is within a printable time contained in the printable condition data, and printing the print data if the time when the instruction was given is within the printable time contained in the matched printable condition data.

In an exemplary embodiment, the method may further comprise the steps of checking whether the time when an instruction to print was given is within a printable time contained in the printable condition data, if printable condition data is provided, and, if the time when an instruction to print the print data was given is not within a printable time contained in the generated printable condition data, allowing a user to select whether to delete print data, and deleting the print data if the user chooses to delete the print data.

According to another aspect of the present invention a print data managing apparatus comprises a checking unit for checking whether printable condition data corresponding to print data is provided, and a printable condition data generating unit for generating printable condition data by obtaining printable condition data corresponding to a keyword input by a user, if printable condition data is not provided.

In an exemplary embodiment, the printable condition data generating unit may comprise a security level determining unit for obtaining a security level corresponding to the input keyword, and for assigning the security level to the print data, and a printable condition data outputting unit for generating printable condition data by obtaining printable condition data corresponding to the assigned security level.

In an exemplary embodiment, the printable condition data generating unit may receive printable condition data and generate printable condition data based on the received printable condition data.

In an exemplary embodiment, the checking unit may check whether the time when an instruction to print the print data was given is within a printable time contained in the generated printable condition data, and the print data managing apparatus may further comprise an image forming unit for printing the print data if the time when the instruction to print the print data was given is within the printable time contained in the generated printable condition data.

In an exemplary embodiment, the checking unit may check whether the time when an instruction to print was given is within a printable time contained in the generated printable condition data, and the print data managing apparatus may further comprise a user interface unit for providing a user interface allowing a user to select whether to delete print data, if the time when instruction to print the print data was given is not within a printable time contained in the generated printable condition data, and a deleting unit for deleting the print data if the user chooses to delete the print data.

In an exemplary embodiment, the checking unit may be in a peripheral or a host device connected to the peripheral.

In an exemplary embodiment, the checking unit may further check whether the input keyword exists in at least one of a name of a print file having the print data and the print data, if printable condition data is not provided, and, if the keyword exists in at least one of the name of a print file having the print data and the print data, the printable condition data generating unit may generate printable condition data.

According to another aspect of the present invention, a computer-readable medium has embodied thereon computer readable code for a method for managing print data comprising the steps of checking whether printable condition data which corresponds to print data is provided, and, if printable condition data is not provided, generating printable condition data by obtaining printable condition data corresponding to a keyword input by a user.

### BRIEF DESCRIPTION OF THE DRAWINGS

The above and other objects, features, and advantages of certain exemplary embodiments of the present invention will be more apparent from the following description taken in conjunction with the accompanying drawings, in which:

FIG. 1 is a block diagram of a device for managing print data according to an exemplary embodiment of the present invention;

FIG. 2 is a flowchart of a method for managing print data according to an exemplary embodiment of the present invention; and

FIG. 3 is a flowchart of a method for managing print data according to another exemplary embodiment of the present invention.

Throughout the drawings, the same reference numerals will be understood to refer to the same elements, features, and structures.

### DETAILED DESCRIPTION OF THE INVENTION

The matters defined in the description such as a detailed construction and elements are provided to assist in a comprehensive understanding of the exemplary embodiments of the invention and are merely exemplary. Accordingly, those of ordinary skill in the art will recognize that various changes and modifications of the exemplary embodiments described herein can be made without departing from the scope and spirit of the invention. Also, descriptions of well-known functions and constructions are omitted for clarity and conciseness.

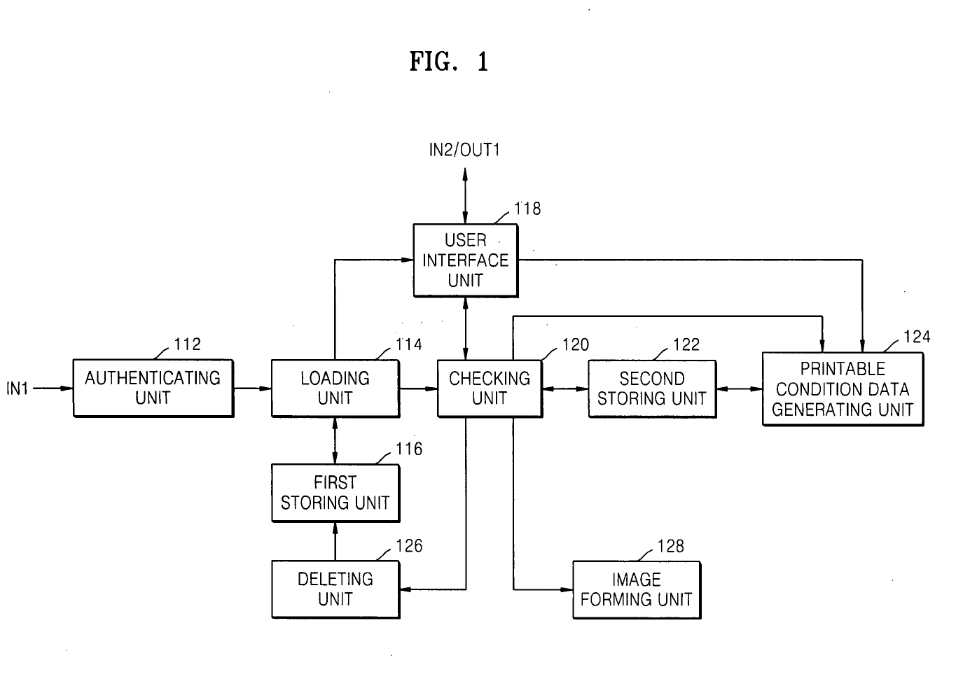

FIG. 1 is a block diagram of a device for managing print data according to an exemplary embodiment of the present invention. The print managing apparatus includes an authenticating unit 112, a loading unit 114, a first storing unit 116, a user interface unit 118, a checking unit 120, a second storing unit 122, a printable condition data generating unit 124, a deleting unit 126, and an image forming unit 128.

The authenticating unit 112, the loading unit 114, the first storing unit 116, the user interface unit 118, the checking unit 120, the second storing unit 122, the printable condition data generating unit 124, the deleting unit 126, and the image forming unit 128, may be provided in an image forming apparatus, such as a multi-function peripheral having a printing function, or a printer.

The print data managed by the method for managing print data and apparatus according to the exemplary embodiment of the present invention may be, for example, print data read from a storage (rather than print data received from a host device connected to the image forming apparatus). The print data may be stored in the image forming apparatus or it may be stored in a storage medium connected to the image forming apparatus. One example of a suitable storage medium for print data is a memory card, such as a USB card.

The authenticating unit 112 receives an instruction to print the print data IN1 and determines whether the user giving the instruction to print IN1 has the necessary rights to give the instruction to print IN1. To make this determination, the authenticating unit 112 may receive information such as the identity of the user giving the instruction to print and/or a password, together with the instruction to print.

When the authenticating unit 112 determines that the identity of the user and/or the password indicates that the user giving the instruction to print has the right to give the instruction to print, the authenticating unit 112 authenticates the instruction to print. On the other hand, when the authenticating unit 112 determines that the user giving the instruction to print does not have the right to give the instruction to print, the authenticating unit 112 does not authenticate the instruction to print.

The loading unit 114 reads the print data to be printed from the stored print data. The print data is preferably printed by the image forming apparatus and then stored in the image forming apparatus. That is, when the print data is initially printed by the image forming apparatus, the print data is not stored in the image forming apparatus. Instead, in the initial printing, the print data is transmitted from the host device connected to the image forming apparatus to the image forming apparatus. After printing the print data, the image forming apparatus stores the print data in the first storing unit 116.

When an authenticated user gives an instruction to print previously printed print data, the loading unit 114 can read the print data from the stored print data in the first storing unit 116.

The user interface unit 118 provides a user interface for displaying the print data read by the loading unit 114. In this case, OUT1 denotes the provided user interface.

Alternatively, the user interface unit 118 may provide a user interface for displaying all the print data stored in the first storing unit 116. A user may then select which print data is to be printed from the displayed print data. In this case, OUT1 is the provided user interface and IN2 is the selection of the print data to be printed which is received from the user.

The checking unit 120 checks whether printable condition data (which will be described in further detail below) corresponding to the print data is provided. If printable condition data is not provided, the checking unit 120 checks whether an input keyword IN2 exists in the print data.

The checking unit 120 may be located in the image forming apparatus or the host device connected to the image forming apparatus. That is, the checking unit 120 may be provided in a peripheral or the host device. Further, the checking unit 120 may be provided in a network server for controlling at least one host device and at least one peripheral.

The second storing unit 122 stores printable condition data. Also, a keyword IN2 may be input through the user interface unit 118.

The checking unit 120 checks whether printable condition data corresponding to the print data is stored in the second storing unit 122. If printable condition data is not stored in the second storing unit 122, the checking unit checks whether the keyword IN2 input through the user interface unit 118 exists in the print data stored in the first storing unit 116. The checking unit 120 may check whether the input keyword IN2 is in the name of a print file containing the print data or whether the input keyword IN2 is in the content of the print data to determine whether the input keyword IN2 exists in the print data.

Here, printable condition data is data for determining whether print data may be printed when an instruction to print IN1 is issued. Printable condition data is preferably determined according to security level.

The security level represents the degree of security for the print data. The security level may be determined according to the content of the print data. Accordingly, printable condition data may be determined according to the content of the print data.

Printable condition data may include a printable time and a printable number for the print data. The printable time of the print data represents how long the print data can be stored. That is, the printable time of the print data may be the retention period of the stored print data. The printable number of the print data represents how many times the print data can be printed.

When the print data is stored in the first storing unit 116, printable condition data corresponding to the stored print data may be stored in the second storing unit 122 to match the stored print data. If the print data is stored in the first storing unit 116 but corresponding printable condition data is not stored in the second storing unit 122, printable condition data is generated. That is, the user interface unit 118 receives printable condition data and the printable condition data generating unit 124 generates printable condition data according to the received content.

Alternatively, the content of printable condition data may be automatically generated based on the content of the print data. In this case, a plurality of printable condition data may be stored in the second storing unit 122. More particularly, the second storing unit 122 may store printable condition data in lookup tables. The printable condition data may then be retrieved using the keyword as an index. Alternatively, it may store the security level using the keyword as an index, and store printable condition data using the security level as an index.

The user interface unit 118 receives the keyword IN2 from the user and the checking unit 120 checks whether the input keyword IN2 exists in the print data to be printed. If the keyword IN2 exists in the print data, the printable condition data generating unit 124 obtains printable condition data from the second storing unit 122 by using the input keyword IN2. The printable condition data generating unit 124 then stores the obtained printable condition data in the second storing unit 122 so that it corresponds with the print data to be printed.

If the input keyword IN2 does not exist in the print data to be printed, the printable condition data generating unit 124 may assign a default condition to the print data to be printed and generate printable condition data using the default condition. Alternatively, the printable condition data generating unit 124 may require the user to input another keyword through the user interface unit 118.

The printable condition data generating unit 124 may include a security level determining unit (not shown) and a printable condition data outputting unit (not shown). Here, the security level determining unit obtains a security level corresponding to the input keyword IN2 from the security levels stored in the second storing unit 122 and assigns the obtained security level to the print data if the input keyword IN2 exists in the print data to be printed.

The printable condition data outputting unit reads printable condition data corresponding to the assigned security level from printable condition data which are previously stored in the second storing unit 122 to generate printable condition data for the print data.

As the result, the printable condition data generating unit 124 reads printable condition data corresponding to the input keyword IN2 from printable condition data which are previously stored in the second storing unit 122 to generate printable condition data corresponding to the print data if the input keyword IN2 exists in the print data.

Accordingly, even if the user who wants to generate printable condition data is not the user who issued the instructions to store the print data or has forgotten the content of the print data, the printable condition data generating unit 124 can evaluate the content of the print data and generate printable condition data based on that evaluation.

The checking unit 120 checks whether the stored print data satisfies printable condition data corresponding to the stored print data. Here, printable condition data corresponding to the stored print data may be previously stored in the second storing unit 122, or may be generated by the printable condition data generating unit 124 and stored in the second storing unit 122. In particular, the checking unit 120 checks whether the time when the instruction to print was given is within the printable time of printable condition data for the stored print data.

If the time when the instruction to print the stored print data was given is not within the printable time, the deleting unit 126 may delete the stored print data from the first storing unit 116 under the instruction of the checking unit 120. However, even if the time when the instruction to print the stored print data was given is not within the printable time, the checking unit 120 does not unconditionally instruct the deleting unit 126 to operate.

That is, if the time when the instruction to print the stored print data was given is not within the printable time, the checking unit 120 instructs the user interface unit 118 to provide a user interface allowing the user to select whether the stored print data should be deleted or not. In this case, when the user chooses to delete the stored print data through the user interface unit 118, the checking unit 120 instructs the deleting unit 126 to operate.

Accordingly, if the stored print data must be retained longer than the initially set retention period, the deleting unit 126 does not unconditionally delete the stored print data even if the retention period elapses.

Furthermore, if the time when the instruction to print the stored print data is within the printable time of printable condition data corresponding to the stored print data, the checking unit 120 instructs the image forming unit 128 to operate. The image forming unit 128 prints the print data according to the instruction to print.

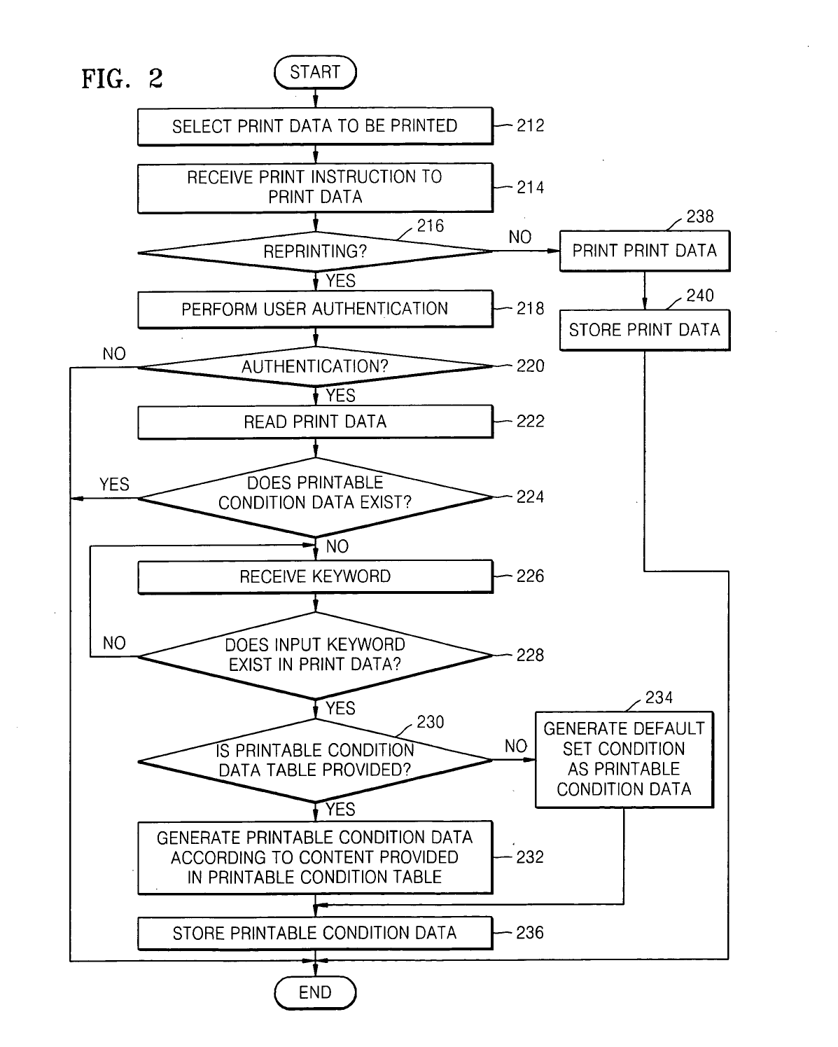

FIG. 2 is a flowchart of a method for managing print data according to an exemplary embodiment of the present invention. The method for managing print data according to the present exemplary embodiment includes operations 212 to 224 of determining whether printable condition data for the read print data is provided, and operations 226 to 236 of evaluating the content of the print data and generating printable condition data corresponding to the evaluated content to match the print data when printable condition data does not exist.

The user interface unit 118 receives print data selected by the user (operation 212) and receives an instruction to print the selected print data (operation 214).

The checking unit 120 checks whether the print data is print data which is reprinted (operation 216). That is, the checking unit 120 checks whether the print data to be printed is stored in the first storing unit 116.

If the print data is print data which is reprinted (operation 216), the authenticating unit 112 determines whether the instruction to print was given by a user having the right to give the instruction to print (operation 218).

If the instruction was given by a user having the right to give the instruction (operation 220), the loading unit 114 reads the print data from the first storing unit 116 (operation 222).

After operation 222, the checking unit 120 checks whether printable condition data corresponding to the print data is stored in the second storing unit 122 (operation 224).

If printable condition data corresponding to the print data is not stored in the second storing unit 122 (operation 224), the user interface unit 118 receives a keyword from the user (operation 226).

The checking unit 120 checks whether the input keyword IN2 exists in the print data (operation 228). If the input keyword IN2 exists in the print data (operation 228), the checking unit 120 checks whether printable condition data is stored in the second storing unit 122 using the keyword as an index (operation 230). That is, the checking unit 120 checks whether printable condition data is stored in a lookup table with the keyword in the second storing unit 122.

Alternatively, if the input keyword IN2 exists in the print data (operation 228), the checking unit 120 checks whether printable condition data is stored in the second storing unit 122 using the security level as the index and whether the security level is stored in the second storing unit 122 using the keyword as the index (operation 230).

If the input keyword IN2 does not exist in the print data (operation 228), the process returns to operation 226 and requires the user to input another input keyword IN2.

If printable condition data is stored in the second storing unit 122 (operation 230), the printable condition data generating unit 124 reads printable condition data corresponding to the input keyword IN2 from the second storing unit 122 and assigns printable condition data to the print data to generate printable condition data for the print data (operation 232).

Alternatively, if printable condition data is stored in the second storing unit 122 (operation 230), the printable condition data generating unit 124 obtains the security level corresponding to the input keyword IN2 from the second storing unit 122. The printable condition data generating unit then obtains printable condition data corresponding to the obtained security level from the second storing unit 122. This printable condition data is then assigned to the print data to generate printable condition data for the print data (operation 232).

After operation 232, the second storing unit 122 stores printable condition data for the print data (operation 236).

At operation 230, if it is determined that printable condition data is not stored in the second storing unit 122, the printable condition data generating unit 124 generates the default condition as printable condition data (operation 234), and the second storing unit 122 stores the generated default printable condition data for the print data (operation 236).

At operation 216, if it is determined that the print data to be printed is not print data which is being reprinted, the image forming unit 128 prints the print data (operation 238), and the first storing unit 116 stores the printed print data (operation 240).

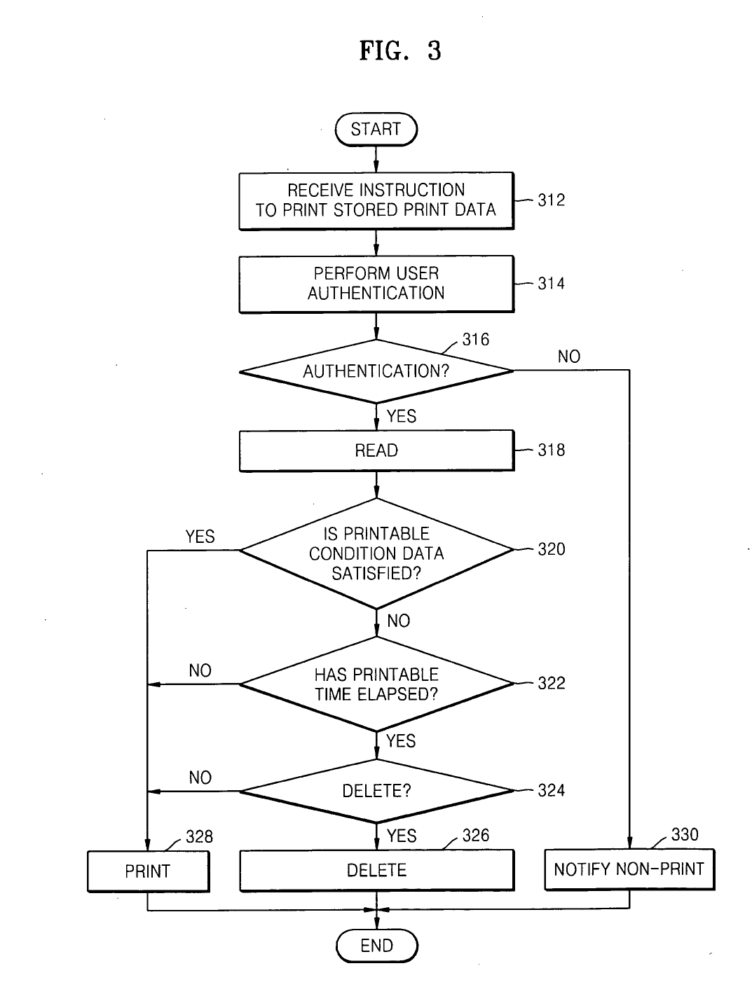

FIG. 3 is a flowchart of a method for managing print data according to another exemplary embodiment of the present invention. The method for managing print data according to the present exemplary embodiment includes operations 312 to 320 of determining whether an instruction to print satisfies printable condition data, and operations 322 to 330 of printing the print data if the instruction to print satisfies printable condition data and deleting the print data from the first storing unit 116 if the instruction to print does not satisfy printable condition data and a deleting instruction is received from the user.

The user interface unit 118 receives print data selected by the user and receives an instruction to print the selected print data (operation 312). Preferably, the selected print data has been previously stored in the first storing unit 116.

The authenticating unit 112 determines whether the instruction to print was given by a user having the right to give the instruction to print (operation 314).

If the authenticating unit 112 determines that the instruction to print was given by a user having the right to give the instruction (operation 316), the loading unit 114 reads the print data from the first storing unit 116 (operation 318).

After operation 318, the checking unit 120 checks whether the instruction to print satisfies printable condition data for the print data (operation 320). More particularly, the checking unit 120 checks whether the time when the instruction to print was given is within the printable time of printable condition data for the print data (operation 322).

If the instruction to print was given at the time that is not within the printable time (operation 322), the user interface unit 118 provides the user with a user interface allowing the user to select whether to delete the print data (operation 324).

If the user chooses to delete the print data (operation 324), the deleting unit 126 deletes the print data from the first storing unit 116 (operation 326). If the user does not choose to delete the print data (operation 324), the image forming unit 128 prints the print data (operation 328).

At operation 316, if the authenticating unit 112 determines that the user does not have the right to give the instruction to print (operation 316), the user interface unit 118 notifies the user that the print data cannot be printed (operation 330).

The present invention can also be embodied as computer readable code on a computer readable recording medium. A computer readable recording medium is any data storage device that can store data which can be thereafter be retrieved by a computer system. Examples of computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code may be stored and executed in a distributed fashion. Also, functional programs, codes, and code segments for accomplishing the present invention can be easily construed by programmers skilled in the art to which the present invention pertains.

As mentioned above, according to the method for managing print data and apparatus of the exemplary embodiments of the present invention, when print data is provided without printable condition data, it is determined whether an input keyword IN2 exists in the print data and, if the input keyword IN2 exists in the print data, the content of the print data is estimated using the keyword. Further, according to the method for managing print data and apparatus of the exemplary embodiments of the present invention, printable condition data for printing the print data can be automatically generated according to the evaluated content. Also, according to the method for managing print data and apparatus of the exemplary embodiments of the present invention, even if the time when the instruction to print the print data was given is not within the printable time of the instruction to print printable condition data, the print data is not unconditionally deleted. That is, it is checked whether an authenticated user wants to delete the print data, and the print data is deleted if the user wants to delete the print data. Thus, the retention period of the print data can be flexibly adjusted.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A method for managing print data comprising the steps of:
checking whether printable condition data which corresponds to print data is provided; and
if printable condition data is not provided, generating printable condition data by obtaining printable condition data corresponding to an input keyword.

2. The method according to claim 1, wherein the step of generating printable condition data comprises the steps of:
reading a security level corresponding to the input keyword, and assigning the security level to the print data; and
generating printable condition data by obtaining printable condition data corresponding to the assigned security level.

3. The method according to claim 1, wherein the step of generating printable condition data comprises the steps of:
receiving printable condition data; and
generating printable condition data based on the received printable condition data.

4. The method according to claim 1, further comprising the steps of:
checking whether the time when an instruction to print the print data was given is within a printable time contained in the generated printable condition data; and
printing the print data if the time when the instruction to print the print data was given is within the printable time contained in the generated printable condition data.

5. The method according to claim 1, further comprising the steps of:
checking whether the time when an instruction to print was given is within a printable time contained in the generated printable condition data;
allowing a user to select whether to delete print data, if the time when an instruction to print the print data was given is not within a printable time contained in the generated printable condition data; and
deleting the print data if the user chooses to delete the print data.

6. The method according to claim 1, wherein the user selects a place from which the print data is read.

7. The method according to claim 1, further comprising the steps of:
checking whether the input keyword exists in at least one of a name of a print file having the print data and the print data, if printable condition data is not provided; and
generating printable condition data, if the keyword exists in at least one of the name of a print file having the print data and the print data.

8. The method according to claim 1, wherein printable condition data comprises at least one of a printable time of the print data and a printable number of the print data.

9. The method according to claim 1, further comprising the steps of:
checking whether the time when an instruction to print was given is within a printable time contained in the printable condition data; and
printing the print data if the time when the instruction was given is within the printable time contained in the matched printable condition data.

10. The method according to claim 1, further comprising the steps of:
checking whether the time when an instruction to print was given is within a printable time contained in the printable condition data, if printable condition data is provided;
allowing a user to select whether to delete print data, if the time when an instruction to print the print data was given is not within a printable time contained in the generated printable condition data; and
deleting the print data if the user chooses to delete the print data.

11. A print data managing apparatus comprising:
a checking unit for checking whether printable condition data corresponding to print data is provided; and
a printable condition data generating unit for generating printable condition data by obtaining printable condition data corresponding to a keyword input by a user, if printable condition data is not provided.

12. The apparatus according to claim 11, wherein the printable condition data generating unit comprises:
a security level determining unit for obtaining a security level corresponding to the input keyword, and for assigning the security level to the print data; and
a printable condition data outputting unit generating printable condition data by obtaining printable condition data corresponding to the assigned security level.

13. The apparatus according to claim 11, wherein the printable condition data generating unit receives printable condition data and generates printable condition data based on the received printable condition data.

14. The apparatus according to claim 11, wherein the checking unit checks whether the time when an instruction to print the print data was given is within a printable time contained in the generated printable condition data, and
the print data managing apparatus further comprises an image forming unit for printing the print data if the time when the instruction to print the print data was given is within the printable time contained in the generated printable condition data.

15. The apparatus according to claim 11, wherein the checking unit checks whether the time when an instruction to print was given is within a printable time contained in the generated printable condition data, and
the print data managing apparatus further comprises:
a user interface unit for providing a user interface allowing a user to select whether to delete print data, if the time when an instruction to print the print data was given is not within a printable time contained in the generated printable condition data; and
a deleting unit for deleting the print data if the user chooses to delete the print data.

16. The apparatus according to claim 11, wherein the checking unit is provided in a peripheral or a host device connected to the peripheral.

17. The apparatus according to claim 13, wherein the checking unit further checks whether the input keyword exists in at least one of a name of a print file having the print data and the print data, if printable condition data is not provided, and the printable condition data generating unit generates printable condition data, if the keyword exists in at least one of the name of a print file having the print data and the print data.

18. A computer-readable medium having embodied thereon computer readable code for a method for managing print data comprising the steps of:
checking whether printable condition data which corresponds to print data is provided; and
if printable condition data is not provided, generating printable condition data by obtaining printable condition data corresponding to an input keyword.

19. A method for managing print data comprising the steps of:
receiving an instruction to print selected print data;
checking whether the print data is print data which is reprinted;
if the print data is print data which is reprinted, determining whether the instruction to print was given by a user having the right to give the instruction to print;
if the instruction was given by a user having the right to give the instruction, reading the print data from a storing unit;
checking whether printable condition data corresponding to the print data is stored in a storing unit;
if printable condition data corresponding to the print data is not stored, receiving an input keyword;
checking whether the input keyword exists in the print data;
if the input keyword exists in the print data, checking whether printable condition data is stored in a storing unit using the keyword as an index; and
if printable condition data is stored in the storing unit, generating printable condition data for the print data.

20. The method according to claim 19, further comprising the step of requiring the user to input another input keyword if the input keyword does not exist in the print data.

21. The method according to claim 19, further comprising the step of generating a default condition as printable condition data if printable condition data is not stored in a storing unit.

22. The method according to claim 19, further comprising the step of printing the print data if it is determined that the print data to be printed is not print data which is being reprinted.
